(19) United States
(12) Patent Application Publication
(10) Pub. No.: US 2014/0363796 A1
(43) Pub. Date: Dec. 11, 2014

(54) Gesture-based cognitive testing

(71) Applicant: Sync-Think, Inc., Boston, MA (US)

(72) Inventor: Matthew E. Stack, Pittsfield, MA (US)

(73) Assignee: Sync-Think, Inc., Boston, MA (US)

(21) Appl. No.: 13/986,845

(22) Filed: Jun. 11, 2013

(51) Int. Cl. G09B 5/02; G06K 9/00

(52) U.S. Cl. CPC G09B 5/02; G06K 9/00335
USPC 434/236

(57) ABSTRACT

Gesture sensing is used as an input to perform cognitive function testing.

### FIELD OF INVENTION

This invention relates to cognitive function testing, and more particularly to sensing gestures to measure cognitive performance.

### BACKGROUND OF THE INVENTION

Recently smooth pursuit eye tracking has been utilized to determine cognitive performance in which a target is moved along a path on a screen in a smooth pursuit fashion. The direction of gaze of the individual taking the test is recorded and the test taker's ability to track the target is measured. Several patent applications that involve smooth pursuit eye tracking are Ser. No. 13/815,571 filed Mar. 11, 2013; Ser. No. 13/507,991 filed Ser. No. 13/507,991 filed Aug. 10, 2012; Ser. No. 12/931,881 filed Feb. 12, 2012; Ser. No. 13/506,870 filed Mar. 11, 2012; Ser. No. 13/694,461 filed Dec. 4, 2012; Ser. No. 13/694,873 filed Jan. 14, 2013, and Ser. No. 13/694,462 filed Dec. 4, 2012, incorporated herein by reference. These inventions relate not only to a headset mounted screen, which encloses the person's head so that environmental factors do not affect the cognitive performance measurement, but also to a desktop unit in which a test taker peers into the desktop unit, whereupon the gaze direction of the test taker is recorded.

These patent applications also describe various measurement metrics, which sensitively and accurately determine cognitive performance and more particularly areas of the brain that may be impaired.

These measurements are highly sensitive, which allows for cognitive functions to be accurately ascertained, with the results being sufficiently reproducible to enable quantification of cognitive ability.

While smooth pursuit eye tracking is useful in predictably measuring cognitive performance, it is only one type of cognitive performance measuring modality. The ability to measure cognitive performance and particularly for instance, brain concussions has been described in US patent application Serial Number 2011/020,567 by R. Kemp Massengill in which a target is moved across a screen and the test taker attempts to track the target by placing his or her finger over the target as it moves. The ability to track such a target is a coarse indication for instance of brain concussion, but may fail to detect various other higher level brain abnormalities or dysfunctions.

More recently, a tablet style system has been provided which attempts to measure brain function utilizing a hand held tablet in which a stylus is used to track the target as it moves along a path. While these types of systems provide a course measure of a brain function they are subject to a number of problems.

One problem is that the finger or the stylus that is used to track the target on the tablet screen obstructs the target while the patient is taking the test. In other words, the finger or the stylus that determines the patient's cognitive performance obstructs the view of the target that the patient has to follow. Thus, touch-screen tablet tests are flawed when they are used to accurately measure cognitive performance.

Another problem with the touch-screen tactile input devices are the variations in the coefficients of friction between the finger or stylus and the screen. How much friction the patient creates while taking the test between the finger or stylus and the screen influences the test's determination or scoring of the patient's cognitive performance. This coefficient of friction can be influenced by various factors including, the way the patient holds the stylus, how much pressure the patient applies to the screen with his or her finger or stylus, variances in arm support, and variances in finger or arm motion.

Instability of the touch base interface for tablets is also another limitation with touch-screen tactile input devices. The portability of the touch base interface creates variation instability depending on the testing environment. Thus, the test results may vary depending on whether the touch base interface is placed on a flat surface or held by the patient or the administrator.

Such cognitive tests taken with touch-screen tactile input devices also require lever arm movement when following the target movement. This then creates muscle-based sources of error when determining the patient's cognitive performance. In other words, the movement of the arm and the patient's arm muscle strength can influence the patient's cognitive test results.

Even if such technology were able to generate accurately reproducible results, the results in practice outside a clinically controlled testing environment are poor due to the limitations listed above. This is also because the touch-screen tablets measure the patient's motor performance, which involves only the cerebellum part of the brain. This testing modality is thus not as cognitively demanding as a smooth pursuit eye movement test that involves more complicated and diverse brain circuitry involving various parts of the brain.

By way of further background, the current state of cognitive testing involves several dominant paradigms including qualitative surveys, reaction time, imaging technologies, biomarker testing, eye tracking and mechanical sensing. Each of these testing paradigms has their own relative merits and limitations when it comes to assessing the brain because it is such a complex organ. Diagnosing or assessing the performance of the brain with a general-purpose tool is fairly difficult to do. Therefore, each of the fields of cognitive testing use subsections of the testing methodology to attempt to diagnose portions of impairments or ailments. However, each has shown to be insufficient at capturing the total picture. As a result, most of these tests are used in combination or in pairs with each other as cost provides.

Starting with perhaps the oldest mechanism and method of testing cognitive impairment is the qualitative survey. However, the survey cognitive testing paradigm is flawed, as it is a qualitative measure of one's cognitive performance. In other words, the survey cognitive testing paradigm depends heavily on the assumption that the subject fully understood the questions, and was honest answering the questions in the survey.

Reaction time testing is a slight improvement over the basic survey. The modern theory of reaction time testing is a measure of the reaction time to a certain stimulus such as a question. For instance, a simple question might include pressing a button whenever an object appears on the screen. A more complex question might involve the patient having to make a decision about something that is presented such as pressing the button when a different color object appears on the screen. With technological advancements, reaction time lags are now measured in milliseconds and measured through a number of modern forms on computer programs and devices designed specifically for reaction time testing. Unfortunately, the reaction time tests generally have a high variability from test to test, and thus the test-retest reliability is fairly low. In addition, in hopes to correct this high variability from test to test, reaction time tests are generally administered a number of times, where that number ranges anywhere from a dozen to hundreds of times, and the results are then averaged. However, this in fact introduces more sources of error by not taking into consideration variables such as the patient's emotions, thoughts, diet, metabolic rate, fatigue as well as the fact that the testing environment may be changing during the test.

Another cognitive testing paradigm uses imaging and signal analysis technologies. Imaging technologies that provide pictures of the brain include CT scans, and functional magnetic resonance imaging (fMRI), as well as technologies that provide waveform signals of the brain such as electroencephalography (EEG) and magneto-encephalography (MEG).

Another cognitive testing paradigm is biomarker testing. The biomarker testing cognitive testing paradigm involves looking for biomarkers or elements in the bloodstream of a patient in response to certain parts of the brain breaking down or metabolizing chemicals in a certain way.

As mentioned previously, the most promising method currently employed for cognitive testing is the eye tracking paradigm and specifically smooth pursuit eye tracking. In smooth pursuit eye tracking, a patient is asked to follow a target that is moving on a screen while a patient's eyes are monitored to see how closely the patient can follow that target on the screen.

It has been discovered that patients who are able to track the target very closely and smoothly have a greater level of cognitive ability. On the other hand, patients who are more erratic in the tracking of a smoothly moving object are shown to have some form of cognitive impairment. This is significant because the parts of the brain that are responsible for tracking smoothly moving objects appear to involve several complex higher order functions within the brain in addition to the lower order functions involved with basic vision. Therefore, if there is a lack of ability or impairment in the ability for one to follow smoothly moving objects, this implies impairment in higher cognitive functions of the patient that are difficult to detect otherwise. Furthermore, the brain circuit involved in performing smooth pursuit seems to track all around the brain, from the optical processing center to the rear of the brain to the neo cortex.

As to mechanical tracking, current state of cognitive testing falls into three broad categories: the remote assessment of position or balance, use of flex-based sensors to vary the resistance based on the degree of bend or curvature of a limb, or the external assessment of the position of a set of objects that the user interacts with such as via optical remote detection.

Balance-based cognitive sensing is a term that refers to the analysis of a test subject's ability to balance on an unstable platform or ability to respond to changes in balance through the perturbation of stimuli that disrupts the patient's vestibular system. Disruption of the vestibular system is associated with the balance of a patient that is driven primarily by the brain's ability to detect and monitor certain inner-ear channels and other sources of sensory data for human body orientation such as the positioning of limbs or the stability of the body core.

Flex-based sensors are a technology borrowed from the gaming interface world, and more recently applied to cognitive testing. This involves the use of flex sensors that specifically change their resistance in response to some flexing or tensioning or torqueing. These flex sensors may be embedded in some textile or article of clothing that is then worn or applied in some way to the test subject.

Remote sensing of objects that a user interacts with can include touchpads placed on the floor, like those associated with a popular arcade game “Dance Dance Revolution”, as well as remote detection of visual tags via optical cameras. Thus, remote sensing involves translating movement into data to determine the rate at which the user can move objects.

However, prior remote sensing technologies suffer a fundamental measurement error in that they are not measuring the actual human body extremities, but instead are measuring human body position through an intermediate object. For instance, the game pad on the ground that is stepped on introduces a timing error and lag. Also, the white “ping pong” balls worn on the outside of clothing used in video media industry to determine user position introduce time lag and translation error between where the balls are placed in space and time, and where the actual subject's body was at the time of the recording. Thus, each of these technologies introduces an intermediate source of error that can be significantly larger than the subtle feature or signal of the physical human body movement associated with the cognitive effect one seeks to measure.

Finally, as mentioned above, cognitive decline or impairment has been measured through the use of touch screens. This technology uses a touch-based input method such as a stylus or finger moving over a resistive or capacitive screen or drawing tablet as an input source. This technique is said to provide sufficient granularity to be able to assess cognitive decline or impairment. While it may be possible to provide this required granularity in the ideal conditions of a lab where patients are subjected to extensive preconditioning, calibration, training and 30 to 60 minutes of setup supervised by a clinician, touch pads are not practical in practice for the reasons stated above.

In summary, there is a need for a sensitive, accurate, reproducible cognitive function measuring device that is portable, light weight, and low cost, without cumbersome equipment, extensive pre-conditions, calibration, training and setup.

### SUMMARY OF THE INVENTION

To solve these problems, gesture sensing is used to measure cognitive performance. While human gesture sensing has been utilized in the past to control computer programs and is used extensively for the control of games, its been found that a new three-dimensional sensing technology which can detect for instance the position of one's finger in the air can be utilized to measure cognitive performance with sufficient granularity and repeatability. As a result, the gesture-based system can measure cognitive performance in terms of anticipatory timing, lead/lag time, radial inbounding, path drift, velocity variability and variance statistics associated with smooth pursuit testing as described in U.S. patent application Ser. No. 13/815,574 filed Mar. 11, 2013. Gesture-based testing can also be used in peak cognitive performance testing as described in U.S. patent application Ser. No. 13/694,462 filed Dec. 4, 2012. The gesture-based system may also be used in multi-modal cognitive performance testing as described in U.S. patent application Ser. No. 13/694,873 filed Jan. 14, 2013. Also gesture-based cognitive performance testing is available for clinical drug development as described in U.S. patent application Ser. No. 13/694,461 filed Dec. 4, 2012 and for drug compliance monitoring as described in U.S. patent application Ser. No. 13/986,617 filed May 16, 2013, with all of the above incorporated herein by reference.

In one embodiment three-dimensional gesture sensing units such as manufactured by Leap Motion and by Duo 3D are utilized to sense the three-dimensional position in space of a person's finger and in turn its motion. These devices use a stereo camera arrangement and three infrared light emitting diodes to track a finger in space. This motion is then used to measure how the path of the finger correlates to a predetermined path, with the degree of correlation measuring cognitive function.

In one embodiment where low level cognitive testing requires detection of only motor function, a patient or test taker may be asked to close his or her eyes and move his or her finger in a circle. The degree to which the person's traced circle corresponds to an ideal circle is a coarse measure of cognitive performance.

In order to provide more granularity and a result similar to that associated with smooth pursuit eye tracking, these same devices may be utilized together with a path presented on-screen. The test taker seeks to mimic the path of an on-screen target by moving his or her finger in the air in such a manner that the resulting on-screen finger trace mimics the on-screen target path. In this case, a finger trace is presented on-screen juxtaposed to the on-screen target path for visual feedback.

As will the appreciated, motion sensing coupled with visual feedback involves more brain circuits than that used for motor control. It involves for instance the optical processing center, the neo cortex, as well as the cerebellum.

As a result, one can measure the cognitive performance of the test taker by analyzing the degree to which the position traced by the test taker's finger matches the target path presented on-screen. This allows for monitoring of higher order functions of the brain in addition to motor control. These higher order function measurements are described above.

What is therefore provided is the use of a three-dimensional gesture sensing system to measure cognitive function. In one embodiment, the three-dimensional gesture systems involve non-visible energy wavelengths that are utilized for monitoring and sensing the position of one's finger or other body part.

This non-tactile finger position sensing eliminates the problem of friction and other problems with finger-to-tablet systems, and provides flexibility in the measuring of cognitive performance by using gestures for the cognitive performance testing.

Whether the gesture sensing system relates to a coarse measurement of motor function, or whether the gesture sensing system measures higher order brain function, the subject gesture sensing system is portable, inexpensive, and requires no calibration or preconditioning in order to perform the test.

Moreover, the stability of a tablet is not involved as the subject gesture sensing system is not dependent on the stability of a tablet that may be on one's lap, on a flat surface, or held up by hand.

As a result, this invention contemplates the use of a cognitive test based on gestures and the use of remote monitoring and sensing.

In one embodiment, during the subject cognitive test, a test subject performs a cognitive test that requires him or her to move an extremity, such as a hand or the body itself, in a certain motion or direction in relation to a remote sensing mechanism. For example, the test subject may be asked to move their finger to trace and follow a moving target in a smooth pursuit type test. As the subject does so, there may or may not be a visible indication that represents the subject's finger position displayed along with the primary target on a display. If the finger trace were visible, it provides visual feedback to the subject. Based on the relative position of the finger to the test target, a number of measurements may be determined. Such data analytics may include metrics such as accuracy, anticipation, coordination, continuity and fluidity.

While the majority of experimentation and application development in remote gesture-based systems is focused on gaming and industrial control applications, no researchers have contemplated the use of a 3D gesture sensing system to measure cognitive function.

The subject invention provides the first accurate, high-resolution mechanical testing paradigm for practical and commercial use. Further, the subject technique does not involve a secondary object to represent the primary object of interest, namely a body part. All previous mechanical cognitive testing paradigms have been too imprecise and erroneous for commercial deployment, or require excessively complex or long calibration and configuration time that is impractical. On the other hand, the subject invention centers on the use of gesturing as a low cost cognitive performance-monitoring paradigm.

Moreover, due to the small size and lightweight portable nature of the electronics involved in gesture-based testing, it is possible to deploy the subject cognitive testing paradigm in areas that previous mechanical cognitive testing was not able to.

For example, the subject technique can be used as a first screening tool in a high throughput testing environment without long calibration and configuration times. It can also be used as a triage technology to suggest to patients whether or not they require additional cognitive testing.

### BRIEF DESCRIPTIONS OF THE DRAWINGS

These and other features of the subject invention will be better understood in connection with the Detailed Description in conjunction with the Drawings, of which:

FIG. 1 is a diagrammatic illustration of a prior tablet type cognitive performance testing unit in which a stylus is utilized to trace the path of a target on the tablet;

FIG. 2 is a diagrammatic illustration of the utilization of a 3D sensing unit, which detects the 3D position of the finger of a test taker, in which the motion of the finger of the test taker is projected onto a computer screen carrying a predetermined target path; and,

FIG. 3 is diagrammatic illustration of the utilization of the overlay of sensed finger movement onto a predetermined target path, with the degree of match indicating a measurement of cognitive function.

### DETAILED DESCRIPTION

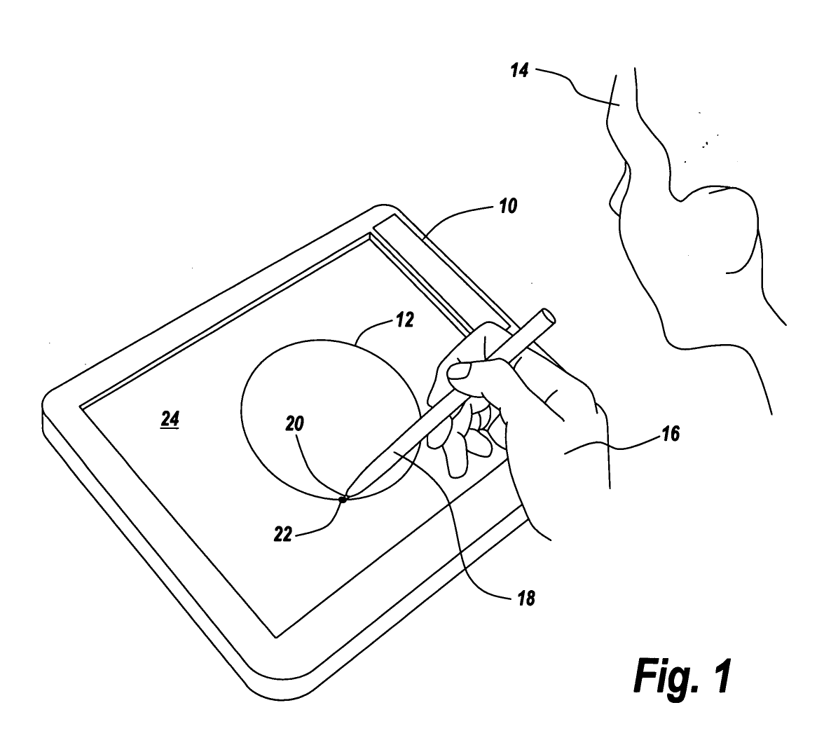

As illustrated in FIG. 1, a tablet 10 projects a predetermined target path 12, in this case a circle, onto a screen 24. A test taker 14 utilizes his hand 16 to guide a stylus 18 along the target path projected onto the tablet. The tip 20 of the stylus is made to correspond to a target 22 traveling along path 12.

This type of cognitive performance measuring system has problems associated with it, not the least of which being that the stylus may interfere with the view of the target as it moves along the path, not to mention the problem of tablet instability when held on one's lap or any frictional characteristics of the stylus with respect to the surface of the screen here shown at 24.

The result of utilizing such a cognitive measuring device is that the results that are obtained are not reliable, vary from one test to the next, and do not result in reproducible results. Moreover, the measurements are so erratic that measure of any high level brain functioning is masked by other factors such as the person's musculature, the lever arm associated with his hand, the lever arm of the stylus with respect to the individual's fingers, and the movement of the tablet, as well as the frictional problems mentioned above.

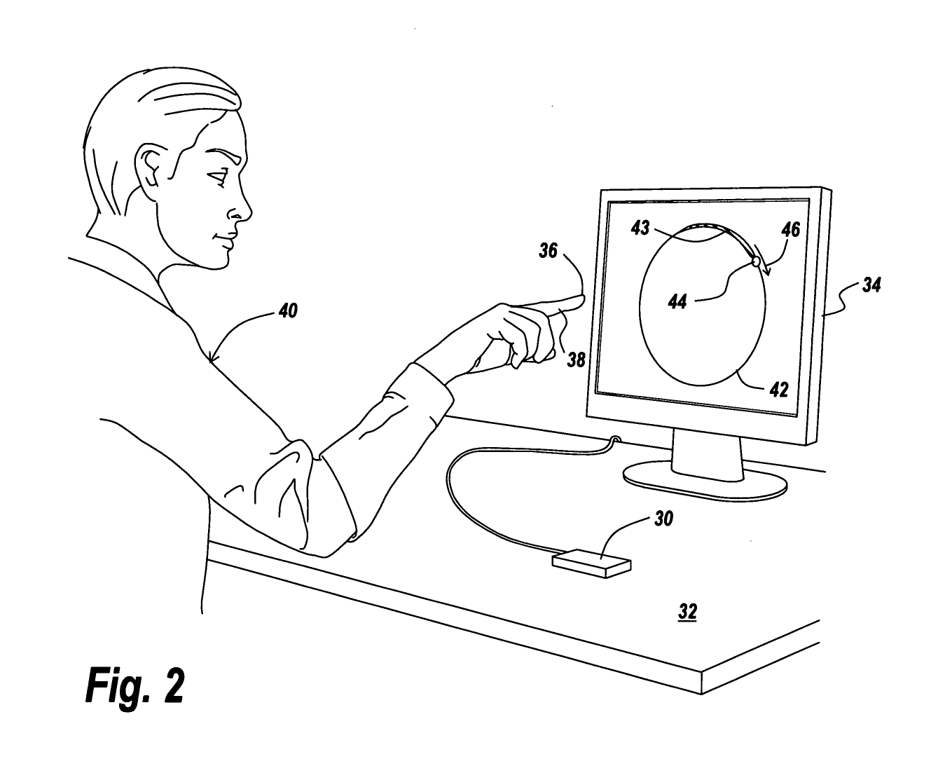

Referring now to FIG. 2, in order to solve the problems associated with the tablet of FIG. 1, a 3D measuring module 30 is placed, in one embodiment on desktop 32 on which is positioned a computer monitor 34. In operation, the module senses the position of the tip 36 of the finger 38 of the test taking individual 40 as the individual moves his finger for instance in a circular motion.

If there is no visual feedback, by decoding the position in space of the tip of the individual's finger the system can determined the degree to which the individual is able to make his finger move in a circle, with the movement of his finger compared to an idealized circle. Regardless of what is shown on-screen, this method constitutes at least a coarse measure of cognitive ability, for instance directed to motor skills governed by cerebellum function.

On the other hand, if the individual is presented with a predetermined smooth pursuit target path 42 around which a target 44 progresses as illustrated by arrow 46, then the visual feedback to individual 40 is used by the individual to help him or her to make sure that the movements of his or her finger match path 42.

The actual position of the finger of the test taker and its motion in space is presented on-screen by path 43 which can be compared with target path 42 to give feedback to the individual as to how well his or her gesturing is performing in the tracking of target 44.

It will be appreciated that a higher level of cognitive ability is required to trace the path of a target in this fashion over that that of the finger-to-tablet systems that mainly require muscle control ability. This target tracking involves the visual cortex, as well as the high level circuits within the brain associated with the individual's eyes when tracking target 44. Thus, the functioning of a number of high-level circuits in the brain may be measured during the subject testing process.

The result of such a measurement is a highly accurate and repeatable metric for determining overall cognitive function, with the test, for instance, engineered to detect which part or function of the brain is impaired.

The particular part of the brain which may be impaired can be isolated by changing the smooth pursuit path pattern as described in the aforementioned patent applications. Additionally, various metrics can be utilized to determine how far behind or in front the individual finger is of the target. Moreover variability in the test taker's ability to track the target is another indictor of cognitive performance. Additionally, as described in the applications mentioned above, the difficulty of the test may be increased or decreased, with the individual's response being recorded. Further, the path configuration may be changed in order to ascertain high-level functionality.

The technology available to be able to sense the finger or any other body part has been demonstrated by the aforementioned commercial 3D trackers, which rather than being utilized to measure cognitive performance are presently utilized for machine control and entertainment functions.

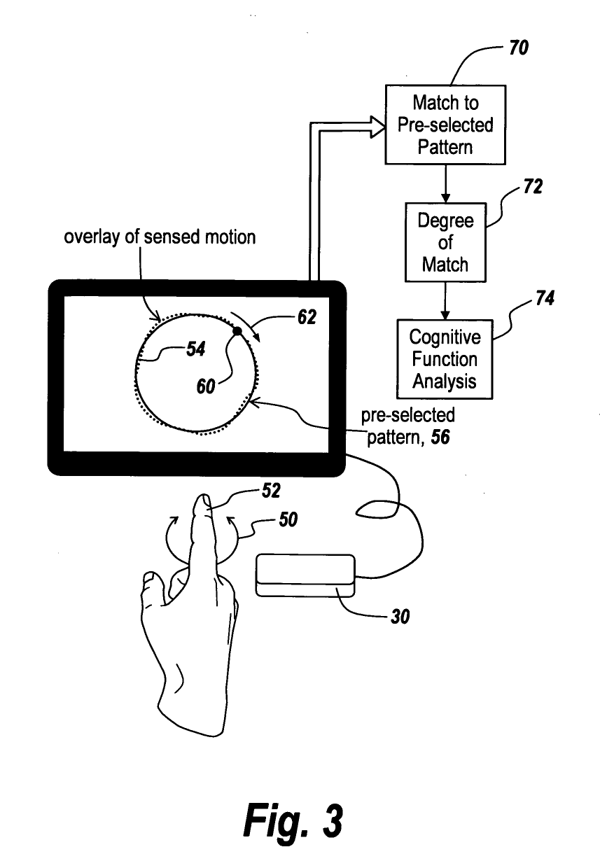

Referring now to FIG. 3, in one embodiment the motion 50 of the test taking individual's finger 52 is sensed by unit 30. As illustrated at 54, this motion is overlaid on top of a predetermined target path 56 as this test tracker moves his or her finger to track target 60 that is moving along the path as illustrated at 62. This is equivalent to a smooth pursuit eye tracking test, but does not require the ability to determine eye gaze direction. As illustrated at 70, the overlay of the sensed motion is compared to the predetermined target path, with the degree of match being determined. In one embodiment, this match is reported as a number, which is used to represent the degree of match 72. The degree of match can be analyzed in any number of ways that can be utilized by cognitive function analysis unit 74 to provide for either a coarse determination of cognitive function or for instance a higher order measure of cognitive performance akin to the type of measurements that can be made utilizing smooth pursuit eye tracking.

The result is the measurement of gestures in free space utilizing a three-dimensional position sensing system, which in one embodiment utilizes non-visible radiation to determine the position in space of a particular point, in this case the finger tip of the individual. Note that when a moving target is presented on-screen, there is no obstruction of the view of the target by the individual's finger and the individual can move his or her finger to mimic that of the moving target without his or her finger obscuring the target.

As long as unit 30 is in a fixed position, the system will provide reliable data that can be utilized in analysis of cognitive function, with the subject system being portable, light weight and inexpensive. Moreover, the test may be performed in the field as it does not require complex setup, long calibration or environmental control. For instance, the test may be used on the sidelines at a football game to help quickly and reliably detect concussions, or used at home to monitor one's cognitive performance.

In summary, cognitive function is measured by utilizing gestures, which are detected by measuring the position of a particular body part in space.

While the subject invention has been described in terms of the utilization of one's finger, other cognitive performance tests can be performed by measuring the position of other body parts in space such as an elbow, shoulder, head or any other body part whose position is monitored in a three-dimensional remote monitoring.

While the present invention has been described in connection with the preferred embodiments of the various figures, it is to be understood that other similar embodiments may be used, or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A gesture-based cognitive performance testing system.

2. The system of claim 1, wherein the system includes a sensor for sensing the three dimensional position in space of a body part of the test taker for whom cognitive performance is to be measured.

3. The system of claim 2, wherein said cognitive performance measuring system includes means for determining where in space said body part is positioned and for determining the motion of said body part.

4. The system of claim 3, wherein said body part includes the test taker's finger.

5. The system of claim 4, and further including a processor for determining a match between the motion of said test taker's finger and a predetermined path.

6. The system of claim 5, wherein the degree of said match measures cognitive performance of said test taker.

7. The system of claim 6, and further including a screen and a target moving on said screen in a smooth pursuit path and wherein said processor determines how closely the sensed motion of the test taker's finger is to the movement of the target on said smooth pursuit path.

8. The system of claim 7, wherein the metric used for determining the match of the movement of the finger to the movement of the on-screen target includes one of variability, regularity, and lead or lag performance.

9. The system of claim 2, wherein said sensor includes stereoscopic cameras.

10. The system of claim 9, wherein said stereoscopic cameras include infrared light emitting diodes.

11. The system of claim 5, wherein said predetermined path includes a circle.

12. The system of claim 7, wherein the movement of said target is along a smooth pursuit path.

13. The system of claim 12, wherein the movement of said target along said smooth pursuit path is variable in terms of target characteristics and path characteristics.

14. A method for determining cognitive performance by sensing a gesture of a test taking individual.

15. The method of claim 14, wherein the sensed gesture includes the movement of the test taking individual's body part.

16. The method of claim 15, wherein cognitive function is determined by the closeness of the path of the movement of the individual's body part to a predetermined path.

17. The method of claim 16, wherein the predetermined path includes a circle.

18. The method of claim 16, wherein the predetermined path is presented on-screen to the test taking individual.

19. The method of claim 18, wherein the position of the individual's body part as it moves is presented on-screen juxtaposed to the predetermined path, whereby the test taking individual is provided with visual feedback.

20. The method of claim 19, and further including a target moving on the predetermined path, whereby the cognitive test includes the ability of the individual to move the individual's body part so that the presented on-screen body part position coincides with the target as it moves along the path.

21. The method of claim 1, wherein the body part includes the finger of the test taker.

22. A system for gesture-based cognitive testing in which the testing includes a gesture-based input.

23. A system comprising a gesture-sensing device as an input to a cognitive performance monitoring system.
